(19) United States
(12) Patent Application Publication
(10) Pub. No.: US 2014/0002219 A1
(43) Pub. Date: Jan. 2, 2014

(54) IRON BASE SOFT MAGNETIC POWDER FOR POWDER MAGNETIC CORES, FABRICATION METHOD FOR SAME, AND POWDER MAGNETIC CORE

(71) Applicants: Hiroyuki Mitani, Kobe-shi (JP); Takeshi Ohwaki, Kobe-shi (JP); Hirofumi Hojo, Takasago-shi (JP); Satoshi Nishida, Shinagawa-ku (JP); Yuji Taniguchi, Takasago-shi (JP)

(72) Inventors: Hiroyuki Mitani, Kobe-shi (JP); Takeshi Ohwaki, Kobe-shi (JP); Hirofumi Hojo, Takasago-shi (JP); Satoshi Nishida, Shinagawa-ku (JP); Yuji Taniguchi, Takasago-shi (JP)

(73) Assignee: Kabushiki Kaisha Kobe Seiko Sho (Kobe Steel, Ltd.), Kobe-shi (JP)

(21) Appl. No.: 14/004,432

(22) PCT Filed: Mar. 11, 2011
(86) PCT No.: PCT/JP2011/055837

§ 371 Date: Sep. 11, 2013

(51) Int. Cl. H01F 3/08; H01F 41/00

(52) U.S. Cl. CPC H01F 3/08; H01F 41/005
USPC 335/297; 427/127; 419/66; 252/62.54

(57) ABSTRACT

This invention addresses the problem of providing an iron base soft magnetic powder for a powder magnetic core that does not use rare metals, that can maintain the electrical insulating properties between the iron powder particles even when subjected to high temperature thermal processing, and that has excellent thermal stability and mechanical strength. This invention also addresses the problem of providing a fabrication method for the iron base soft magnetic powder for the powder magnetic core, and providing the powder magnetic core. In this iron base soft magnetic powder for the powder magnetic core, a phosphatized coating film is formed on the surface of the iron base soft magnetic powder, and a silicon resin coating film is formed on the surface of the phosphatized coating film. The phosphatized coating film contains P, B, Mg, and Al.

### TECHNICAL FIELD

The present invention relates to iron base soft magnetic powder for powder magnetic cores, a method of manufacturing the iron base soft magnetic powder for powder magnetic cores, and a powder magnetic core produced using the iron base soft magnetic powder for powder magnetic cores.

### BACKGROUND ART

Magnetic cores configured of laminated magnetic steel sheets or electrical sheets have been traditionally used as magnetic cores for electromagnetic components such as motors and transformers operated on AC. Recently, however, a powder magnetic core, which is formed through compression forming of iron base soft magnetic powder for powder magnetic cores such as pure iron powder or soft magnetic iron base alloy powder, each particle of the powder having an insulated surface, has been increasingly used since such a powder magnetic core has a high degree of freedom in three-dimensional shape and high magnetic properties compared with the magnetic core configured of laminated magnetic steel sheets or electrical sheets. Hereinafter, pure iron powder, soft magnetic iron base alloy powder, and the like may be collectively referred to as iron base soft magnetic powder for powder magnetic cores.

With a previously known iron base soft magnetic powder for powder magnetic cores such as the pure iron powder and the soft magnetic iron base alloy powder, each particle of the powder having an insulated surface, or with a previously known powder magnetic core produced through compression forming of the iron base soft magnetic powder for powder magnetic cores, PTL1 proposes a technology where a surface of each particle of iron base soft magnetic powder is covered with a glassy insulating layer produced from phosphoric acid or the like. PTL2 proposes a technology where a surface of each particle of iron base soft magnetic powder is oxidized in air to form an oxide coating on the surface in order to improve adhesion between each particle of the iron base soft magnetic powder and the glassy insulating layer. However, although such an inorganic insulating coating such as the glassy insulating layer must be excellent in thermal stability, insulating properties thereof have been disadvantageously degraded after heat treatment (annealing) at high temperature.

From such a viewpoint, silicone resin having high heat resistance is used for an insulating coating in a previously developed technology. In a technology described in PTL3, a specified methylphenyl silicone resin is used as an insulating material. In such a technology, however, 1 percent by mass or more of resin is used with respect to iron powder to secure certain thermal stability, and therefore there is still room for improvement in light of high density forming. PTL4 and PTL5 each propose a technology in which glass powder or pigment is added to silicone resin to secure certain heat resistance. In such a technology, however, densification has been disadvantageously inhibited by adding the glass powder or the pigment.

Thus, the inventors have proposed a technology as described in PTL6. The proposed technology relates to iron base soft magnetic powder for powder magnetic cores, in which a phosphatized coating and a silicone resin coating are provided in this order on a surface of each particle of iron base soft magnetic powder, the phosphatized coating containing at least one element selected from a group consisting of Co, Na, S, Si, and W. The inventors have combined the phosphatized coating having such a composition with the silicone resin coating, thus achieving formation of an electrical insulating film having increased heat resistance. However, while the phosphatized coating contains such elements, Co and W are rare metals being not easily available, thereby disadvantageously leading to high cost. It has been therefore desired to develop a technology to be widely used, which provides advantageous effects similar to those of the above technology while employing easily available materials to avoid an increase in cost.

### CITATION LIST

### Patent Literature

PTL1: Japanese Unexamined Patent Application Publication No. 6-260319.

PTL2: Japanese Unexamined Patent Application Publication No. 8-167519.

PTL3: Japanese Unexamined Patent Application Publication No. 2002-83709.

PTL4: Japanese Unexamined Patent Application Publication No. 2003-303711.

PTL5: Japanese Unexamined Patent Application Publication No. 2004-143554.

PTL6: Japanese Patent No. 4044591.

### SUMMARY OF INVENTION

### Technical Problem

An object of the present invention, which has been made to solve the above-described problems, is to provide iron base soft magnetic powder for powder magnetic cores, the powder having excellent thermal stability and mechanical strength, in which no rare metal is used, and electric insulation is maintained between iron powder particles even when subjected to high-temperature heat treatment. A further object of the invention is to provide a method of manufacturing the iron base soft magnetic powder for powder magnetic cores, and a powder magnetic core produced using the iron base soft magnetic powder for powder magnetic cores.

### Solution to Problem

Iron base soft magnetic powder for powder magnetic cores according to the present invention is characterized in that a phosphatized coating is provided on a surface of each particle of iron base soft magnetic powder, and a silicone resin coating is provided on a surface of the phosphatized coating, the phosphatized coating containing P, B, Mg, and Al.

The iron base soft magnetic powder for powder magnetic cores preferably contains 0.010 to 0.100 parts by mass of P, 0.001 to 0.010 parts by mass of B, 0.001 to 0.020 parts by mass of Mg, and 0.005 to 0.050 parts by mass of Al with respect to 100 parts by mass of the iron base soft magnetic powder, each particle of the powder having the phosphatized coating on a surface thereof.

A method of manufacturing the iron base soft magnetic powder for powder magnetic cores is characterized by having a step of mixing a phosphatizing solution containing B, Mg, and Al with iron base soft magnetic powder, and then evaporating water and/or an organic solvent to form a phosphatized coating on a surface of each particle of the iron base soft magnetic powder, and a step of mixing a silicone resin solution prepared by dissolving a silicone resin in an organic solvent with the iron base soft magnetic powder, each particle of the powder having the phosphatized coating on a surface thereof, and then evaporating the organic solvent to form a silicone resin coating on the phosphatized coating.

The powder magnetic core according to the present invention is characterized by being produced through compression forming of the iron base soft magnetic powder for powder magnetic cores.

### Advantageous Effects of Invention

According to the invention, heat resistance of the phosphatized coating can be improved only by adding typical elements such as B, Mg, and Al without using any rare metal that is expensive and is not easily available. Moreover, the phosphatized coating is combined with the silicone resin coating, which makes it possible to form an electrical insulating layer having increased heat resistance.

Moreover, the phosphatized coating containing P, B, Mg, and Al is formed on the surface of the iron-base soft magnetic powder material, which makes it possible to secure high heat resistance and high electrical insulating properties. Furthermore, this makes it possible to densify the powder magnetic core produced using the iron base soft magnetic powder for powder magnetic cores.

Consequently, the powder magnetic core manufactured using the iron base soft magnetic powder for powder magnetic cores of the invention has high performance, in other words, satisfies all the characteristics demanded for magnetic cores of the electromagnetic components such as motors and transformers operated on AC, i.e., satisfies any of high magnetic flux density, low iron loss, and high mechanical strength.

### DESCRIPTION OF EMBODIMENTS

The inventors performed powder compaction of particles of an iron base soft magnetic powder material, each particle having, on its surface, a coating including only phosphoric acid or a coating including a glassy insulating layer prepared from phosphoric acid or the like as described in PTL1, so that a powder compact (powder magnetic core) was produced. In addition, the inventors measured the specific resistance (μΩ·m) of the powder compact with temperature being varied. As a result, in any example, it was found that the specific resistance of the powder compact was lowered to about 10 μΩ·m through treatment at 450° C. (for 1 hr under a nitrogen atmosphere).

The inventors made investigations on a cause of such a reduction in specific resistance, and finally estimated as follows. That is, oxygen atoms, which had come from the phosphoric acid contained in the phosphoric-acid base coating, diffused and were bonded to Fe to form Fe oxide during high-temperature heat treatment. Such Fe oxide acted as semiconductor, causing the reduction in specific resistance. The inventors considered that thermal stability of the phosphoric-acid base coating was possibly improved by inhibiting formation of the oxide acting as semiconductor by any appropriate approach, and made investigations based on such consideration. Finally, the inventors completed the technology as described in PTL6.

In the invention described in PTL6, however, while the phosphatized coating contained the several elements, Co and W were rare metals being not easily available, thereby disadvantageously leading to high cost. Thus, the inventors made further investigations based on an idea that similar advantageous effects were possibly obtained even if typical elements were added in place of such rare metals. As a result, the inventors found that similar advantageous effects were also obtained by a phosphatized coating containing P, B, Mg, and Al in place of the rare metals, thereby achieving the present invention.

Hereinafter, the present invention will be described in further detail based on one embodiment.

In the iron base soft magnetic powder for powder magnetic cores of the invention, a phosphatized coating and a silicone resin coating are provided in this order as insulating coatings on a surface of each particle of iron base soft magnetic powder. The inner phosphatized coating of the insulating coatings is provided to secure certain electrical insulating properties. The top silicone resin coating is provided to improve thermal stability of the electrical insulating properties and exhibit certain mechanical strength. The iron base soft magnetic powder for powder magnetic cores is mixed with a lubricant described later as necessary, and is then subjected to compression forming so as to be used as magnetic cores of electromagnetic components such as motors and transformers mainly operated on AC.

The iron base soft magnetic powder is ferromagnetic metal powder, specific examples of which include pure iron powder, iron base alloy powder including Fe—Al alloy, Fe—Si alloy, Sendust, and Permalloy, and amorphous powder. For example, such iron base soft magnetic powder is manufactured through preparation of fine particles by an atomizing process, reduction of the fine particles, and pulverization of the reduced particles. According to such a manufacturing method, iron base soft magnetic powder is produced, the powder having a particle diameter of about 20 to 250 μm, at which cumulative grain size distribution reaches 50% in grain size distribution determined by a sieving method. In the invention, however, iron base soft magnetic powder having an average particle diameter of about 50 to 150 μm is preferably used.

To manufacture the iron base soft magnetic powder for powder magnetic cores of the invention, a phosphatized coating is first formed on a surface of each particle of iron base soft magnetic powder. The phosphatized coating is a glassy coating prepared through phosphatizing of orthophosphoric acid (H₃PO₄) (sometimes simply referred to as phosphoric acid) or the like.

In the invention, however, the phosphatized coating must contain P, B, Mg, and Al. The reason for this is as follows. That is, it has been found that such elements are particularly effectively contained together to inhibit bonding between Fe and oxygen atoms in the phosphatized coating during high-temperature heat treatment in order to suppress the reduction in specific resistance during the heat treatment.

To suppress the reduction in specific resistance during high-temperature heat treatment by addition of such elements, the phosphatized coating preferably contains 0.010 to 0.100 parts by mass of P, 0.001 to 0.010 parts by mass of B, 0.001 to 0.020 parts by mass of Mg, and 0.005 to 0.050 parts by mass of Al with respect to 100 parts by mass of the iron base soft magnetic powder, each particle of the powder having the phosphatized coating on its surface.

Among such elements, P is chemically bonded via oxygen to the surface of each particle of the iron base soft magnetic powder. Hence, if the content of P is excessively small, the amount of such chemical bonding becomes insufficient. This may prevent formation of a strong coating. On the other hand, if the content of P is excessively large, unreacted P remains in the coating while contributing to no chemical bonding. As a result, the bonding strength is rather reduced. Consequently, the content of P is specified to be 0.010 to 0.100 parts by mass to avoid any problem for formation of a strong coating.

B, Mg, and Al each inhibit bonding of Fe to oxygen during high-temperature heat treatment (high-temperature annealing), and thus exhibit the effect of suppressing the reduction in specific resistance. In particular, if such elements are added together, such effects are conspicuously exhibited; hence, B, Mg, and Al must be collectively added together with P. If the content of each of such elements is excessively small, the effect of suppressing the reduction in specific resistance is not exhibited. On the other hand, if the content of each of such elements is excessively large, and if the elements are added together, relative balance between the elements may not be maintained. In addition, such large content may inhibit the chemical bonding via oxygen between P and the surface of each particle of the iron base soft magnetic powder. Consequently, the content of B is specified to be 0.001 to 0.010 parts by mass, the content of Mg is specified to be 0.001 to 0.020 parts by mass, and the content of Al is specified to be 0.005 to 0.050 parts by mass.

The phosphatized coating preferably has a thickness of 1 to 250 nm. If the phosphatized coating has a thickness of less than 1 nm, the phosphatized coating is less likely to exhibit a certain insulating effect. If the phosphatized coating has a thickness of more than 250 nm, the insulating effect is saturated, and densification of the formed powder magnetic core is inhibited. The deposition amount of the phosphatized coating is preferably about 0.01 to 0.8 parts by mass.

A compound containing P, B, Mg, and Al (or each element itself) is dissolved in an aqueous solvent to prepare a phosphatizing solution (treatment liquid). The resultant phosphatizing solution is then mixed with iron base soft magnetic powder and dried to form the phosphatized coating. Specifically, first, orthophosphoric acid (H₃PO₄) and others are dissolved in an aqueous solution to prepare a treatment liquid containing a solid content of about 0.1 to 10 parts by mass. Then, 1 to 10 parts by mass of the treatment liquid is added to 100 parts by mass of the iron base soft magnetic powder, and such materials are mixed by a mixer, a ball mill, a kneader, a V-mixer, a granulator, or the like. The mixture is then dried at 150 to 250° C. in air, under reduced pressure, or under vacuum to form a phosphatized coating.

Examples of the compounds containing P, B, Mg, and Al include orthophosphoric acid (H₃PO₄) as a P source, boric acid (H₃BO₃) as a B source, magnesium oxide (MgO) as a Mg source, and Al(H₂PO₄)₃ as a source of P and Al. B, Mg, and Al may each be added not only in a form of the compound but also directly. Examples of the aqueous solution include water, hydrophilic organic solvents such as alcohols and ketones, or mixtures thereof. A surfactant may be added into the aqueous solution.

Then, a silicone resin coating is formed on the phosphatized coating. While the silicone resin coating is configured of a silicone resin, particles of the silicone resin are firmly bound together through a crosslinking/curing reaction, or during forming of the powder magnetic core. As a result, mechanical strength of the formed powder magnetic core increases. In addition, Si—O bonding having excellent heat resistance is formed through the reaction, and therefore an insulating coating having excellent thermal stability is produced.

Such a silicone resin preferably contains a large amount of trifunctional T units (RSiX₃: X denotes a hydrolyzable group) compared with difunctional D units (R2SiX2: X denotes a hydrolyzable group). This is because if the resin is slowly cured, the D units cause sticky powder and in turn cause bad handling after formation of the coating. If the silicone resin contains a large amount of tetrafunctional Q units (SiX₄: X denotes a hydrolyzable group), particles of the resin are firmly bound together during pre-curing described later, which may disadvantageously inhibit subsequent forming. Consequently, it is recommended that the silicone resin coating includes 60 mol % or more, preferably 80 mol % or more, and most preferably 100 mol % of a silicone resin coating having T units.

Consequently, in the invention, a methylphenyl silicone resin having 50 mol % or more methyl groups is preferably used as the silicone resin. Furthermore, a methylphenyl silicone resin having 70 mol % or more methyl groups is more preferably used. Most preferably, a methylphenyl silicone resin having no phenyl group is used. KR255 and KR311 from Shin-Etsu Chemical Co., Ltd. may be exemplified as the methylphenyl silicone resin having 50 mol % or more methyl groups. KR300 from Shin-Etsu Chemical Co., Ltd. may be exemplified as the methylphenyl silicone resin having 70 mol % or more methyl groups. KR251, KR400, KR220L, KR242A, KR240, KR500, and KC89 from Shin-Etsu Chemical Co., Ltd. and SR2400 from Dow Corning Toray Co., Ltd. may be exemplified as the methylphenyl silicone resin having no phenyl group. A ratio of methyl groups to phenyl groups of a silicone resin and functionality of each group can be analyzed as by FT-IR.

The silicone resin coating preferably has a thickness of 1 to 300 nm. More preferably, the thickness is 10 to 200 nm. Assuming that the total amount of the iron base soft magnetic powder, each particle of the powder having the phosphatized coating on its surface, and the silicone resin coating is 100 parts by mass, the deposition amount of the silicone resin coating is preferably 0.01 to 0.5 parts by mass. If the deposition amount of the silicone resin coating is less than 0.01 parts by mass, insulating properties thereof are degraded, resulting in a reduction in electric resistance. If the deposition amount of the silicone resin coating exceeds 0.5 parts by mass, the powder magnetic core is less likely to be densified.

The total thickness of the silicone resin coating and the phosphatized coating is preferably 500 nm or less. If the total thickness exceeds 500 nm, magnetic flux density may be significantly reduced.

To form the silicone resin coating on the surface of the phosphatized coating, a silicone resin, which is dissolved in at least one of alcohols or petroleum organic solvents such as toluene and xylene, should be mixed with the iron base soft magnetic powder followed by volatilization of such an organic solvent. In a preferable, but not limitative, formation condition of the silicone resin coating, 0.5 to 10 parts by mass of the silicone resin solution, which is prepared to have a solid content of 2 to 10 parts by mass, is added to 100 parts by mass of the iron base soft magnetic powder, each particle of the powder having the phosphatized coating on its surface, and such materials are mixed, and the mixture is then dried to form the silicone resin coating. If the adding amount of the silicone resin solution is less than 0.5 parts by mass, much time may be taken for mixing, or the coating may be unevenly formed. On the other hand, if the adding amount of the silicone resin solution exceeds 10 parts by mass, much time may be taken for drying, or drying may be insufficient. The silicone resin solution can be appropriately heated beforehand. The above materials may be appropriately mixed by a mixer, a ball mill, a kneader, a V-mixer, a granulator, or the like.

In the final, drying step of formation of the silicone resin coating, the silicone resin solution is preferably heated to a temperature, which is high enough for the organic solvent used for formation of the silicone resin coating to volatilize but is lower than the curing temperature of the silicone resin, to sufficiently vaporize the organic solvent. Specifically, in the case where the organic solvent is at least one of alcohols or petroleum organic solvents, the drying temperature is preferably about 60 to 80° C. After such drying, to remove any agglomerated portion, the iron base soft magnetic powder (iron base soft magnetic powder for powder magnetic cores), each particle of the powder having the silicone resin coating on its top, is preferably passed through a sieve having an opening of about 300 to 500 μm.

After the drying, it is recommended that the silicone resin coating is pre-cured. Such a pre-curing process refers to a process for finishing a softening step in curing of the silicone resin coating while the iron base soft magnetic powder for powder magnetic cores is still powdery. The pre-curing process allows the iron base soft magnetic powder for powder magnetic cores to maintain certain fluidity even during warm forming at about 100 to 250° C. In a specific procedure of the pre-curing process, the iron base soft magnetic powder for powder magnetic cores is simply heated for a short time near the curing temperature of the silicone resin to be used. Alternatively, a curing agent may be used. In the pre-curing process, the particles of the iron base soft magnetic powder for powder magnetic cores are easily crushed since the particles do not strongly adhere to one another due to incomplete curing. On the other hand, in the high-temperature curing process (complete curing process) performed after forming of the iron base soft magnetic powder for powder magnetic cores, the particles of the iron base soft magnetic powder for powder magnetic cores adhere together since the silicone resin is completely cured. Such a complete curing process increases the strength of the compact of the powder magnetic core.

As described above, the silicone resin coating is pre-cured and then crushed, thereby the iron base soft magnetic powder, having excellent fluidity, for powder magnetic cores is produced. Consequently, the sandy iron base soft magnetic powder for powder magnetic cores is smoothly charged into a forming die in a subsequent compression forming step. If the pre-curing process is not performed, the iron base soft magnetic powder for powder magnetic cores may adhere to a forming die, and thus may not smoothly charged into the forming die. In addition, the finally resultant powder magnetic core has an extremely increased specific resistance through the pre-curing process. While the reason for this is not clear, one possible reason is as follows: the pre-curing process contributes to improve adhesion after the complete curing between the silicone resin coating and the iron base soft magnetic powder for powder magnetic cores.

In the case where the pre-curing is performed by a short-time heating process, a heating process for 5 to 100 min at 100 to 200° C. is preferable. A heating process for 10 to 30 min at 130 to 170° C. is more preferable. The pre-cured iron base soft magnetic powder for powder magnetic cores is also preferably passed through a sieve having an opening of about 300 to 500 μm.

The iron base soft magnetic powder for powder magnetic cores of the invention may further contain a lubricant. The lubricant exhibits an effect of reducing frictional resistance between the particles of the iron base soft magnetic powder for powder magnetic cores, the frictional resistance occurring during compression forming of the powder, and reducing frictional resistance between the iron base soft magnetic powder for powder magnetic cores and an inner wall of a forming die. This suppresses occurrence of die galling by the compact and heat generation during forming. To effectively exhibit such an effect, at least 0.2 parts by mass of the lubricant is preferably contained in the total amount of the iron base soft magnetic powder for powder magnetic cores. However, an excessively high content of the lubricant adversely affects densification of the powder magnetic core; hence, the content of the lubricant is preferably up to 0.8 parts by mass. When a die wall lubrication process is performed as the compression forming, forming is performed after a lubricant is applied onto an inner wall surface of a forming die. In such a case, the content of the lubricant may be less than 0.2 parts by mass.

Examples of the lubricant may include powder of metal stearate such as zinc stearate and calcium stearate, paraffin, wax, natural resin derivatives, and synthetic resin derivatives.

As described above, the iron base soft magnetic powder for powder magnetic cores is first charged into a forming die for compression forming in order to produce the powder magnetic core using the iron base soft magnetic powder for powder magnetic cores. Such a compression forming process may include, but not limitedly, conventional compression forming processes. An example of such a compression forming process is now described.

In compression forming, a compacting pressure condition is preferably 490 to 1960 MPa, and more preferably 790 to 1180 MPa. In particular, when compression forming is performed at a compacting pressure of 980 MPa or more, a compressed core having a density of about 7.50 g/cm³ is easily produced, and thus a compressed core, which has high density and excellent magnetic properties (magnetic flux density), is preferably produced. Although either normal-temperature forming or warm forming (100 to 250° C.) may be performed, warm forming is preferably performed in the die wall lubrication process since a compressed core having higher strength is produced thereby.

After the compression forming, heat treatment (annealing) is performed at high temperature to reduce hysteresis loss of the compressed core. In this heat treatment, temperature is preferably high, i.e., 400° C. or more. If the specific resistance is not degraded, further high temperature is more preferable. The heat treatment may be performed in any non-oxygen containing atmosphere without limitation, but is preferably performed in an inactive atmosphere such as a nitrogen atmosphere. The heat treatment is performed for any period without limitation as long as the specific resistance is not degraded, but preferably performed for 20 min or more, more preferably for 30 min or more, and most preferably for 1 hr or more.

### EXAMPLE

The present invention is now described in more detail with Example. The invention, however, should not be limited to the following Example, and modifications or alterations thereof may be appropriately made within the scope without departing from the gist of the invention, all of which are included in the technical scope of the invention.

In each case, pure iron powder (ATOMEL® 300NH from Kobe Steel Ltd., having average particle diameter of about 80 to 100 μm) was used as the iron base soft magnetic powder. An undiluted solution including 1000 parts by mass of water and 193 parts by mass of H₃PO4 was used in comparative example 1. An undiluted solution including 1000 parts by mass of water, 193 parts by mass of H₃PO₄, 61 parts by mass of MgO, and 30 parts by mass of H₃BO₃ was used in comparative example 2. An undiluted solution including 1000 parts by mass of water, 88.5 parts by mass of NaHPO₄, 181 parts by mass of H₃PO₄, 61 parts by mass of H₂SO₄, and 30 parts by mass of Co₃(PO₄)₂ was used in each of comparative examples 3 and 4. An undiluted solution including 1000 parts by mass of water, 193 parts by mass of H₃PO₄, 31 parts by mass of MgO, 30 parts by mass of H₃BO₃, and 323 parts by mass of Al(H₂PO₄)₃ was used in each of inventive examples 5 and 6. Five parts by mass of a processing solution, which was prepared by diluting each of the undiluted solutions to 10%, was added to 100 parts by mass of the pure iron powder. After the processing solution was added, the materials in each example were mixed by a V-mixer for at least 30 min. Then, the mixture was dried for 30 min in air at 200° C., and was then passed through a sieve having an opening of 300 μm.

A methylphenyl silicone resin having no phenyl group was then dissolved in toluene to yield a resin solution having a solid content concentration of 5 percent by mass (comparative examples 1 to 3 and inventive example 5) or a resin solution having a solid content concentration of 10 percent by mass (comparative example 4 and inventive example 6). Such resin solutions were each added to the pure iron powder such that resin solid content was 0.1 percent by mass (comparative examples 1 to 3 and inventive example 5) or 0.2 percent by mass (comparative example 4 and inventive example 6). Such materials were then mixed and dried for 30 min in air at 200° C., and then each dried mixture was subjected to a pre-curing process for 30 min at 150° C.

The resultant powder was heated to 130° C., and then subjected to compression forming (die wall lubrication process) at a compacting pressure of 1176 MPa with a die, which was also heated to 130° C., having a surface coated with zinc stearate dispersed in alcohol as a lubricant. Each of the formed compacts had dimensions of 31.75 mm×12.7 mm×about 5 mm. Afterword, all the comparative examples and inventive examples were subjected to heating for 30 min under a nitrogen atmosphere at two conditions of 550° C. and 600° C.

Each of the resultant compacts was subjected to measurement of density, transverse rupture strength (by a three-point bend test in accordance with Standard JPMA M 09-1992 of Japan Powder Metallurgy Association), and specific resistance. Table 1 shows details of the results of such measurement and the manufacturing conditions of the compacts.

TABLE 1

| | | | | Heat treatment | Density of | | Specific |
|---|---|---|---|---|---|---|---|
| | | Additive element in | Adding amount | temperature | compact | Transverse rupture | resistance |
| | No. | phosphatized coating | of silicone resin | (° C.) | (g/cm³) | strength (MPa) | (μΩ · m) |
| Comparative | 1 | P | 0.1% | 550 | 7.54 | 62.0 | 10.0 |
| example 1 | 2 | | | 600 | 7.55 | 64.0 | 0.1 |
| Comparative | 3 | P, B, Mg | 0.1% | 550 | 7.54 | 50.8 | 21.7 |
| example 2 | 4 | | | 600 | 7.54 | 52.0 | 0.1 |
| Comparative | 5 | P, Na, S, Co | 0.1% | 550 | 7.50 | 100.0 | 280.3 |
| example 3 | 6 | | | 600 | 7.51 | 93.0 | 127.1 |
| Comparative | 7 | P, Na, S, Co | 0.2% | 550 | 7.48 | 90.4 | 426.5 |
| example 4 | 8 | | | 600 | 7.48 | 95.2 | 152.3 |
| Inventive | 9 | P, B, Mg, Al | 0.1% | 550 | 7.50 | 89.1 | 535.2 |
| example 5 | 10 | | | 600 | 7.50 | 101.2 | 101.7 |
| Inventive | 11 | P, B, Mg, Al | 0.2% | 550 | 7.48 | 91.3 | 942.4 |
| example 6 | 12 | | | 600 | 7.48 | 104.7 | 178.0 |

In the comparative example 1, the phosphatized coating containing P was provided on the surface of each particle of the iron base soft magnetic powder. In the comparative example 2, the phosphatized coating containing P, B, and Mg was provided on the surface of each particle of the iron base soft magnetic powder. In each of the comparative examples 3 and 4, the phosphatized coating containing P, Na, S, and Co was provided on the surface of each particle of the iron base soft magnetic powder. In each of the comparative examples 3 and 4, although any of compact density, transverse rupture strength, and specific resistance was excellent, Co, which was a rare metal being not easily available, was necessary to be used as an additive element. In contrast, in each of the inventive examples 5 and 6, the phosphatized coating containing P, B, Mg, and Al was provided on the surface of each particle of the iron base soft magnetic powder, i.e., only typical elements being easily available were used as additive elements.

Table 1 reveals that each of the inventive examples 5 and 6, in which the phosphatized coating containing P, B, Mg, and Al is provided on the surface of each particle of the iron base soft magnetic powder, is excellent in compact density, transverse rupture strength, and specific resistance as with the comparative examples 3 and 4, and is also excellent in balance therebetween. In the case of heat treatment temperature of 550° C., each of the inventive examples 5 and 6 is excellent in specific resistance compared with each of the comparative examples 3 and 4. In the case of heat treatment temperature of 600° C., each of the inventive examples 5 and 6 is excellent in transverse rupture strength compared with each of the comparative examples 3 and 4.

In the case where the phosphatized coating containing B, Mg, and Al is provided on the surface of each particle of the iron base soft magnetic powder, i.e., in the comparative example 2 using no aluminum as an additive element, excellent measurement results are not given even compared with the comparative example 1.

Although the embodiment and the Examples of the present invention have been described, the invention is not limited to the above-described embodiment, and various modifications and alterations thereof may be made within the scope of the description of claims.

1. A powder, wherein:
the powder is an iron based soft magnetic powder,
a surface of each particle of the iron based soft magnetic powder is coated with a phosphatized coating comprising P, B, Mg, and Al, and
a surface of the phosphatized coating is coated with a silicone resin coating.

2. The powder according to claim 1, wherein
the phosphatized coating comprises:
with respect to 100 parts by mass of the iron based soft magnetic powder,
from 0.010 to 0.100 parts by mass of P,
from 0.001 to 0.010 parts by mass of B,
from 0.001 to 0.020 parts by mass of Mg, and
from 0.005 to 0.050 parts by mass of Al.

3. A method of manufacturing the powder according to claim 1, the method comprising:
mixing a phosphatizing solution comprising P, B, Mg, and Al with the iron based soft magnetic powder,
subsequently evaporating water, a first organic solvent, or both to form the phosphatized coating on the surface of each particle of the iron based soft magnetic powder, thereby obtaining an iron based soft magnetic powder coated with the phosphatized coating,
mixing a silicone resin solution prepared by dissolving a silicone resin in a second organic solvent with the iron based soft magnetic powder, coated with the phosphatized coating, and
subsequently evaporating the second organic solvent to form the silicone resin coating on the phosphatized coating.

4. A magnetic core, produced by a process comprising: compression forming the powder according to claim 1.

5. A method of manufacturing the powder according to claim 2, the method comprising:
mixing a phosphatizing solution comprising P, B, Mg, and Al with the iron based soft magnetic powder,
subsequently evaporating water, a first organic solvent, or both to form the phosphatized coating on the surface of each particle of the iron based soft magnetic powder, thereby obtaining an iron based soft magnetic powder coated with the phosphatized coating,
mixing a silicone resin solution prepared by dissolving a silicone resin in a second organic solvent with the iron based soft magnetic powder coated with the phosphatized coating, and
subsequently evaporating the second organic solvent to form the silicone resin coating on the phosphatized coating.

6. A magnetic core, comprising the powder according to claim 1.
